(19) United States
(12) Patent Application Publication
(10) Pub. No.: US 2011/0125616 A1
(43) Pub. Date: May 26, 2011

(54) Buffered Bookkeeping

(75) Inventors: Xingjun Ni, Hangzhou (CN); Li Cheng, Hangzhou (CN); Xu Zhao, Hangzhou (CN)

(73) Assignee: Alibaba Group Holding Limited, Grand Cayman (KY)

(21) Appl. No.: 12/602,638

(22) PCT Filed: Jul. 2, 2009
(86) PCT No.: PCT/US09/49549

§ 371 Date: Dec. 1, 2009

(30) Foreign Application Priority Data
Jul. 4, 2008 (CN) 200810133018.3

(51) Int. Cl. G06Q 40/00

(52) U.S. Cl. 705/30

(57) ABSTRACT

A method and a system use buffered bookkeeping to update an account timely for a user to see the account information without having to wait until the next accounting date. The method records request events to generate a buffer record of the request events for an account having high-volume concurrent transactions, and fetches and processes the buffer record periodically at predetermined time intervals or recursively for bookkeeping of the request events in the account without waiting for the next accounting date. The transaction funds in the account are made available for inquiries and become accessible after only a short period of time upon the occurrence of the transaction. The length of the delay is configurable according to the level of concurrent transactions of the account.

### RELATED APPLICATIONS

This application is a national stage application of international patent application PCT/US09/49549 filed Jul. 2, 2009, entitled “BUFFERED BOOKKEEPING” which claims priority from Chinese patent application, Application No. 200810133018.3, filed Jul. 4, 2008, entitled “METHOD AND SYSTEM FOR BUFFERED BOOKKEEPING”, which applications are hereby incorporated in their entirety by reference.

### TECHNICAL FIELD

The present disclosure relates to data processing technologies, and particularly relates to methods and systems for computerized bookkeeping.

### BACKGROUND

During an accounting process in which a fund is transferred from one account to another account, both accounts involve a bookkeeping process. A bookkeeping process primarily includes two parts, one part being bookkeeping voucher recording, and the other being account balance update.

An example of bookkeeping is found in a trading process, especially one that relates to an event of bookkeeping request. Resource locks are first placed on accounts related to the trading (which accounts may include a payment account of a buyer, and a recipient account of a seller) to ensure that the accuracy of data is not affected by other requests. Bookkeeping of the payment account, which includes bookkeeping voucher recording and balance update, is then performed, and followed by bookkeeping of the recipient account which also includes bookkeeping voucher recording and balance update. After the bookkeeping request event is completely processed, the resource locks are released altogether.

Generally, relevant accounts are required to be locked in each bookkeeping operation in order to avoid other operations from being further performed on a currently processed account and causing data inconsistency. Locking is a primary method for realizing concurrent control. As the volume of business continues to increase, certain accounts may have multiple concurrent operations in the same instant. However, only one thread out of all concurrent threads can possess a resource lock at a time, while other threads are required to wait until the lock is released to conduct bookkeeping accordingly. Under these circumstances, functionality of a billing system is severely affected.

For example, thousands of lottery players may make payments to a lottery account at the same time, resulting in thousands of requests in a queue for the lottery account at that moment. If each request needs to obtain a locking right before being processed, the system's processing of other transactions may be severely affected.

One existing solution is to use a buffer mechanism. The existing buffer mechanism only keeps a journal for a bookkeeping operation of a recipient account (e.g., temporarily recording a posting voucher), but postpones the update of the account balance. That is, the existing buffer mechanism carries out interim processing of related bookkeeping request for the account without conducting a true bookkeeping operation. This interim processing does not require locking an account, and is thus able to meet a high-volume concurrent transactions demand of a single resource, and ensures other related transactions to be conducted normally.

With respect to updating the balance of an account, the account balance is summarized every day with a daily bookkeeping update of the count. At the end of an accounting date, a system summarizes the account balance based on a bookkeeping journal of the accounting date of the account. Specifically, the account balance is updated at the end of each accounting date. A dividing line between accounting dates is defined by a predetermined time point, e.g., 21:00, in which case an accounting date extends from 21:00 to approximately 20:59 of the next calendar day.

In essence, the existing technology temporarily buffers high-volume concurrent requests, and then serially processes the requests recorded in the buffer to avoid affecting normal operations of other transactions. The existing technology also distributes the processing pressure of the system by spreading the data within a peak interval to multiple time intervals for gradual processing. However, there are problems with this technique. Although users are allowed to check billing details in real time, the details are not correlated with the real account balance because the true balance is not reflected until the next accounting date. Therefore the balancing rule for user account checking, which requires the present balance to be equal to sum of billing details, is not satisfied. Furthermore, a fund received by the user cannot be seen and used until the next accounting date. For example, a certain account may have received funds related to ten transactions, but still needs to wait until next accounting date to actually access the funds.

### SUMMARY

Disclosed are a method and a system which use buffered bookkeeping to update an account timely for a user to see the account information without having to wait until the next accounting date. The method records request events to generate a buffer record of the request events for an account having high-volume concurrent transactions, and fetch and process the buffer record at predetermined time intervals or recursively for bookkeeping of the request events in the account without waiting for the next accounting date. The transaction funds in the account are made available for inquiries and become accessible after only a short period of time upon the occurrence of the transaction. The length of the delay is configurable according to the level of concurrent transactions of the account.

In one embodiment, the method divides the buffer record into a plurality of records each containing request events sent from another respective account, and assigns a processing thread to each of the plurality of records to process the plurality of records in the background.

The processing of the buffer record may include the steps of placing a resource lock on the account having high-volume concurrent transactions, performing bookkeeping, and releasing the resource lock. The buffer record may be deleted after the buffer record has been processed.

In one embodiment, the method records request events continuously to generate a plurality of buffer records each includes a plurality of request events. The method further sequentially fetches and processes the plurality of buffer records for bookkeeping of the request events in the account without waiting for a next accounting date.

According to another aspect of the disclosure, a method for computerized bookkeeping of an account involving financial transactions establishes a first account and a plurality of second accounts. The first account has high-volume concurrent transactions with the plurality of second accounts. The method receives a plurality of request events initiated on behalf of one or more of the plurality of second accounts, and processes each of the request events as the request event takes place for bookkeeping of the respective second account which initiated the request event. At the same time, the method records the plurality of request events to generate a buffer record thereof for the first account, and fetches and processes the buffer record for bookkeeping of the request events in the first account without waiting for a next accounting date.

The disclosed system for computerized bookkeeping of an account involving financial transactions includes a storage, a buffer storage unit and a bookkeeping unit. The storage stores a first account and a plurality of second accounts, wherein the first account has high-volume concurrent transactions with the plurality of second accounts. The buffer storage unit is adapted for recording a plurality of request events initiated on behalf of one or more of the plurality of second accounts to generate a buffer record thereof for the first account. The bookkeeping unit is programmed to fetch and process the buffer record for bookkeeping of the request events in the first account without waiting for a next accounting date.

According to the exemplary embodiments of the present disclosure, the disclosed method and system may have the following technical benefits.

First, the method aims at an account having high-volume concurrent transactions. The method temporarily records each request event using a storage region, and subsequently performs bookkeeping by recording the related bookkeeping information and updating the account balance to complete the bookkeeping steps unfinished by the earlier requests. Differing from existing technologies, a request event is buffered. The method does not separate recording bookkeeping information and updating the account balance but instead performs the both operations synchronously at a back-end stage. Furthermore, the back-end stage processing can be completed in a short period of time, without waiting until the next accounting date to conduct a daily summary of the account. As such, billing details and account balance can be updated synchronously to satisfy the account checking requirement of a user. Moreover, the funds are available for inquiries and become accessible in a shorter period of time. The short delay can be configured according to the level of concurrent transactions of an account.

Second, the present disclosure provides two alternative methods of fetching and processing a buffer record during the back-end stage processing. One is to fetch and process the buffer records periodically at predetermined time intervals. This is suitable for an account having relatively large volume of business but without a strict time delay requirement. The other is to fetch and process the buffer records recursively by starting another batch right after completely processing the current batch. This is suitable for an account having very large volume of business and has a shorter time delay requirement.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. In the figures, the use of the same reference numbers in different figures indicates similar or identical items.

FIG. 1 shows a flow chart of an exemplary overall process of buffered bookkeeping in accordance with the present disclosure.

FIG. 2 shows a flow chart of an exemplary process of restoring and processing a buffer record as used in the exemplary overall process of FIG. 1.

FIG. 3 shows a schematic diagram illustrating an exemplary bookkeeping process of an account having low-volume transactions (e.g., a buyer's account) in accordance with the present disclosure.

FIG. 4 shows a schematic diagram illustrating an exemplary bookkeeping process of an account having high-volume transactions (e.g., a seller's account) in accordance with the present disclosure.

FIG. 5 shows a diagram of a first exemplary system for buffered bookkeeping in accordance with the present disclosure.

FIG. 6 shows a structural diagram of a second exemplary system for buffered bookkeeping in accordance with the present disclosure.

### DETAILED DESCRIPTION

In order to better understand the goals, characteristics and benefits, the disclosed method and system are described below in further detail using accompanying figures and exemplary embodiments.

The buffered bookkeeping method described herein is used for high-volume concurrent financial requests. The method aims at an account having high-volume concurrent transactions, temporarily records each request event using a buffer storage region, and then records bookkeeping information and updates the account at a back-end stage to complete unfinished bookkeeping work of the original requests.

The disclosed method can be suitably applied in various scenarios of financial processing in a number of fields such as online shopping, fair purchasing, and concert ticket purchasing. Moreover, the method is particularly suitable for processing concurrent payment requests where payments are being made at the same time from multiple accounts to a single account.

The method is described below in details using exemplary embodiments involving touches transactions. A buyer purchases a product from a seller, and needs to send a payment to the seller's account. The seller's account may be referred to as a recipient account, while the buyer's account is referred to as a payment account. Specifically, the payment is transferred from the payment account to the recipient account.

The process involves interests of two role types. The first type is a user who possesses an account (such as a buyer or a seller), and is referred to as “user” in short. The second type is a system which provides billing and payment service, and is referred to as “system” in short.

From a user's perspective, there is both a desire to see bookkeeping journal information (i.e., billing details) in real time in order to verify the trading status and terms, and a desire to have account balance timely updated and made available to use in real time.

From the system's perspective, there is a desire to have real-time processing in a high-volume concurrent transactions situation in order to evenly distribute the processing pressure of the system and ensure that other related transactions are normally processed.

In order to satisfy the above requirements of the users and the system, the exemplary embodiments of the method for buffered bookkeeping use an example in which multiple accounts send payments to a single account at the same time.

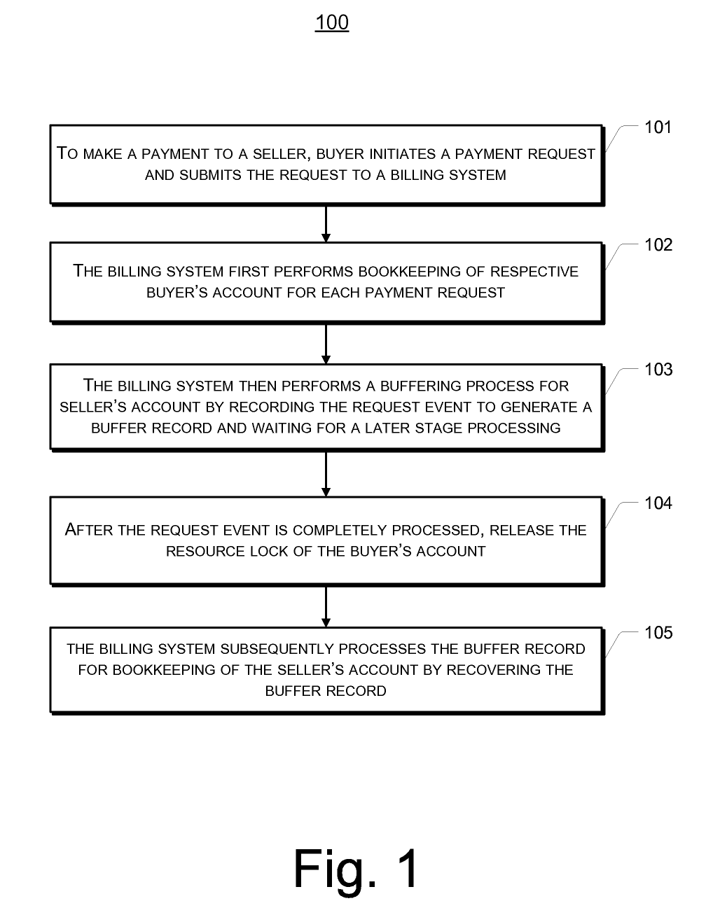

FIG. 1 shows a flow chart of an exemplary process 100 for buffered bookkeeping in accordance the present disclosure. In this description, the order in which a process is described is not intended to be construed as a limitation, and any number of the described process blocks may be combined in any order to implement the method, or an alternate method. The process 100 is described as follows.

At block 101, to make a payment to a seller in a high-volume concurrent transactions situation, a buyer initiates a payment request and submits the request to a billing system. Multiple buyers may be submitting payments at the same time or within a very short period of time.

At block 102, for each payment request, the billing system first conducts bookkeeping of the respective buyer's account. In order to perform bookkeeping, a resource lock may need to be placed upon the buyer's account. The bookkeeping may include the following operations:

1) placing a resource lock on the respective buyer's account;

2) recording a bookkeeping voucher in a bookkeeping journal; and

3) updating the respective account balance (e.g., deducting a payment from the respective buyer's account).

As the buyer's account does not experience high-volume transactions, the bookkeeping of the buyers account may not require a buffer process.

At block 103, the billing system then conducts a buffering process for the seller's account, and waits for further bookkeeping processing which takes place at a later stage (i.e., a back-end stage). A buffering process may only record the request event to generate a buffer record, but does not conduct any actual bookkeeping operation (such as voucher recording and account balance update).

The billing system may record each request into a buffer region in form of a journal, and generate buffer records which are subsequently entered into the billing system sequentially for bookkeeping after a certain period of time. The buffer region may be a storage device as a database, a server, a hard disk, a memory, or a part thereof

At block 104, after the request event has been processed as described above, the resource lock on the buyer's account may be released.

At block 105, the billing system subsequently processes the buffer record for bookkeeping of the seller's account by restoring the buffer record. In one embodiment, the buffer record is processed at a back-end stage by the billing system separately.

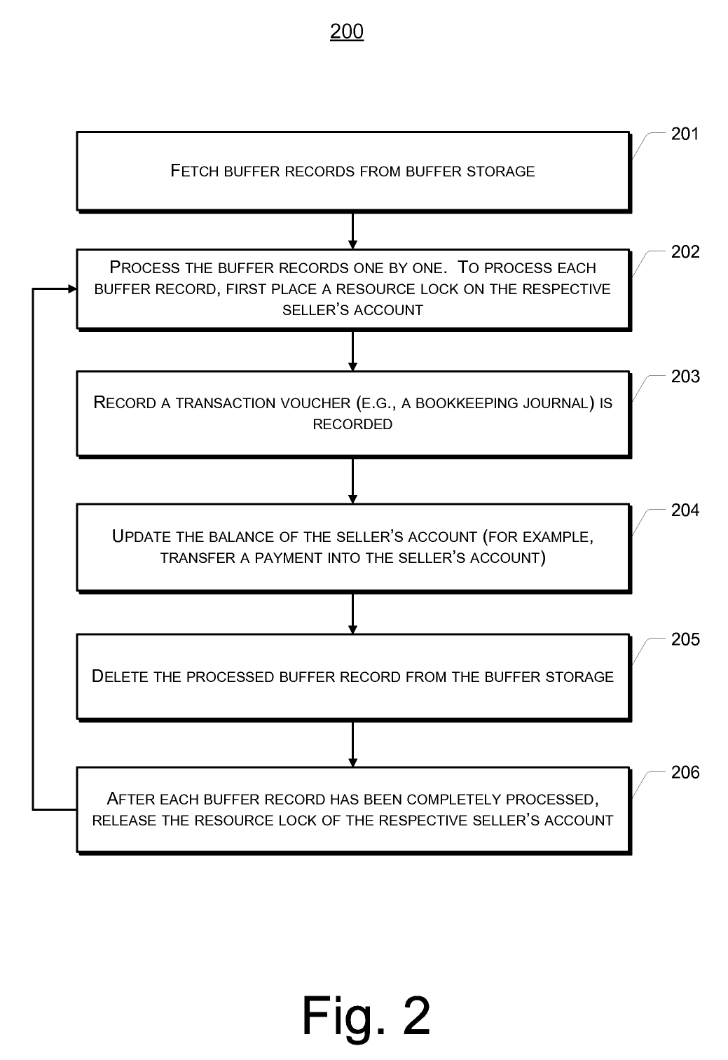

FIG. 2 shows a flow chart of an exemplary process 200 of buffered bookkeeping by restoring a buffer record.

At block 201, the billing system fetches one or more buffer records stored in the buffer storage. Two exemplary fetching methods may be used. One is fetching periodically at predetermined time periods. This is suitable for an account having relatively large volume of business but does not have a strict time delay requirement. The other is recursive fetching, which fetches a new batch of buffer records right finishing processing a batch of buffer records previously fetched. A delay may or may not be used between two adjacent fetches. This is suitable for an account having very large volume of business and also has a shorter time delay requirement. In either case, the fetching does not need to wait until the next accounting date to start. But instead, the fetching and the subsequent processing for the buffered bookkeeping may start within a short period of time after the occurrence of the business transaction.

After the buffer record is fetched, the billing system may divide the buffer record into multiple records each containing request events sent from a respective buyer's account, and assigns a processing thread to each of the multiple records to process them in the background. In other words, each buyer's account is allocated a processing thread based on a division of the record for backend processing. This helps to reduce processing time.

At 202, the billing system starts to process the fetched buffer records one by one. The process each buffer record, a resource lock is first placed on the respective seller's account.

At 203, a bookkeeping voucher is recorded as a bookkeeping journal. This is a part of the bookkeeping process of the seller's account.

At 204, the balance of the seller's account is updated. For example, a payment made by a respective buyer is transferred into the seller's account. This is another part of the bookkeeping process of the seller's account.

At 205, the relevant buffer record is deleted from the buffer region in order to facilitate the subsequent processing.

At 206, after the present buffer record has been processed as described above, the resource lock on the seller's account may be released. The process then returns to 202 to continue to process the other fetched buffer records. After all the fetched buffer records completely processed, the process returns to 201 to fetch a new batch of one or more new buffer records for restoration and bookkeeping.

It is appreciated that the billing system may either fetch and process just one buffer record at a time, or fetch a batch of multiple buffer records at once and wait to fetch another batch after the current batch has been processed.

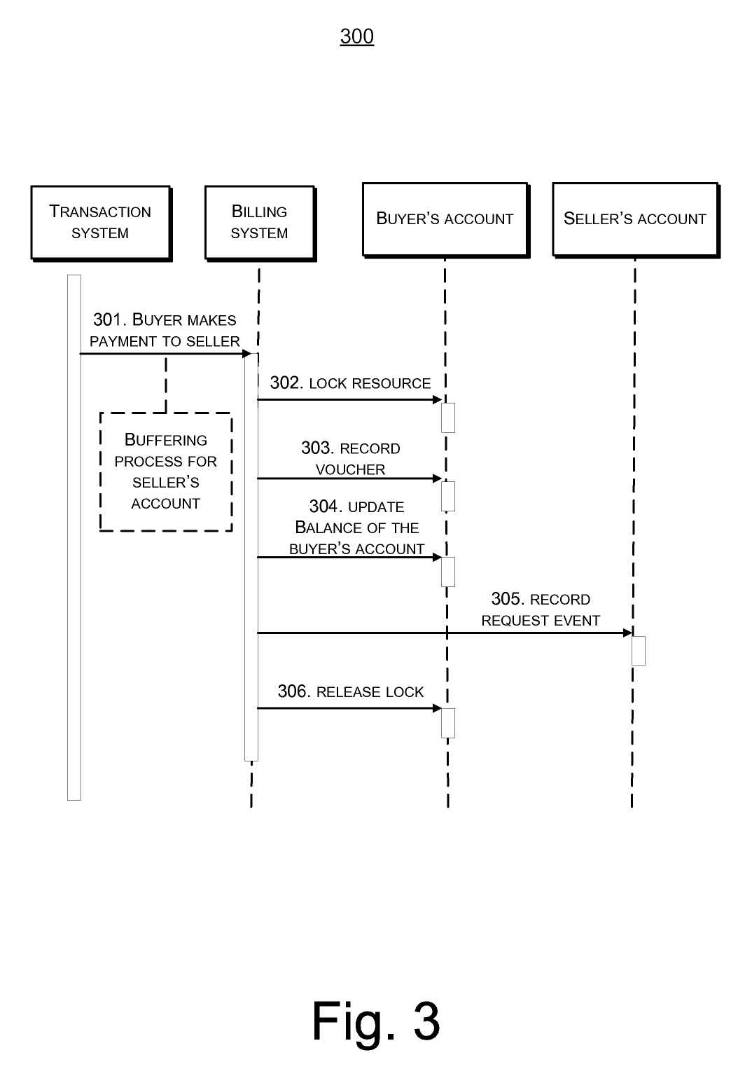

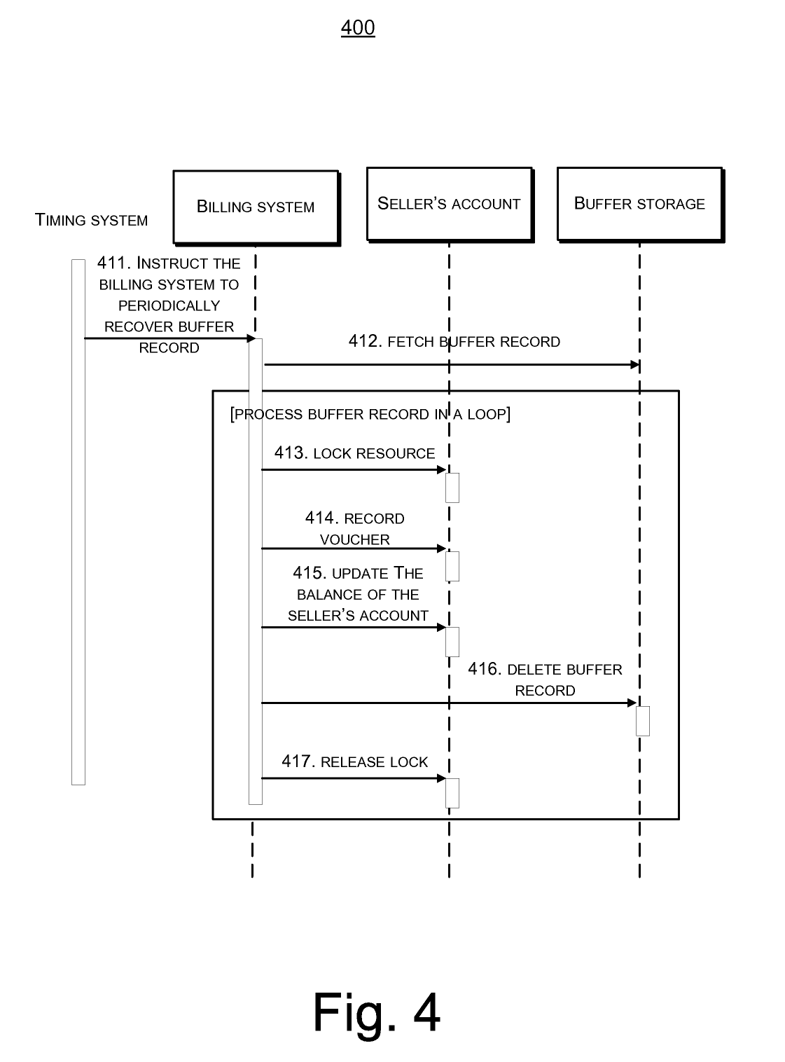

The above processes are further illustrated in FIG. 3 and FIG. 4. FIG. 3 shows a schematic diagram illustrating an exemplary bookkeeping process 300 of an account having low-volume transactions (e.g., a buyer's account) in accordance with the present disclosure. FIG. 4 shows a schematic diagram illustrating an exemplary bookkeeping process 400 of an account having high-volume transactions (e.g., a seller's account) in accordance with the present disclosure.

In FIG. 3 and FIG. 4, the billing system may either be a part of a transaction system which conducts sales, or a separate system working in collaboration with the transaction system. In either case, the billing system is preferably a third-party payment system owned by neither the buyer nor the seller.

The billing system has virtual user accounts, which may include a buyer's virtual account and a seller's virtual account. In practice, the billing system may include virtual accounts of many buyers and virtual accounts of multiple sellers. The buyer first transfers a fund from a bank account into the buyer's virtual account. The transferred fund may either be a deposit fund to pay multiple transactions, or a transaction fund meant to pay for a particular transaction. A transaction fund is then transferred from the buyer's virtual account into the seller's virtual account during a transaction process. At this stage, the transaction fund is under control of a third-party payment platform (such as the billing system), and therefore the seller is not allowed to withdraw the fund immediately. After the buyer has confirmed the satisfactory receipt of the purchased goods, the transaction fund is then transferred from the seller's virtual account into the seller's bank account. The disclosed method can therefore be used for processing requests sent concurrently from multiple virtual accounts held by buyers to a single virtual account held by a seller in a billing system.

In FIG. 3 and FIG. 4, a transaction system is a platform for conducting a transaction between a buyer and a seller over a network, and is primarily used for completing a transaction and recording the related transaction information. During a transaction process, the transferring of a transaction fund is completed by the billing system. In event of a transaction, the transaction system submits a request to the billing system to be processed. Upon completing processing of a transaction fund as described herein, the billing system returns a processing result to the transaction system so that the transaction system may continue to complete the transaction process. In a practical application, the transaction system and the billing system may act together as a third-party payment platform. In certain applications however, a transaction system may be separated from the third-party payment platform such as a billing system.

The exemplary bookkeeping process 300 of a buyer's account illustrated in FIG. 3 is summarized as follows. This process 300 does not need to be buffered.

At 301, the buyer makes payment to the seller using the billing system. While the payment is processed for the buyer's account as illustrated in FIG. 3, the billing system conducts the buffering process for the seller's account by storing the payment request in the buffer storage.

At 302, the billing system locks the resource of the buyer's account.

At 303, the billing system records a bookkeeping voucher of the payment request into the buyer's account.

At 304, the billing system updates the balance of the buyer's account.

At 305, the billing system records the request event into the seller's account.

At 306, the billing system releases the resource lock of the buyer's account.

The exemplary buffered bookkeeping process 400 of a seller's account as illustrated in FIG. 4 is summarized as follows.

At 411, a timing system instructs the billing system to periodically restore and process buffer records for bookkeeping. The timing system may be part of the billing system. The timing system may not be needed if the process uses recursive fetching of the buffer records.

At 412, the billing system fetches a buffer record and processes the fetched buffer record. If multiple buffer records are fetched, the billing system uses a loop process to process the fetched buffer records one by one. Each loop includes the following steps 413-417.

At 413, the billing system locks the resource of the seller's account.

At 414, the billing system records a bookkeeping voucher into the seller's account.

At 415, the billing system updates the balance of the seller's account.

At 416, the billing system deletes the processed buffer record. This step may either be performed for each cycle of a loop, or performed after the loop has been completed.

At 417, the billing system releases the resource lock of the seller's account.

The fetching of buffer records is controlled by a timing system, which instructs the billing system to fetch buffer record from a buffer region for processing at a certain time. In one embodiment, the timing system is used for controlling the billing system to fetch buffer records at every regular time interval, which may be customized according to the actual system need or transaction need.

In the above illustrated buffered bookkeeping of the account having high-volume concurrent transactions, the billing details (such as bookkeeping vouchers) and the update of the account balance are conducted synchronously for each buffer record. Although the bookkeeping of the account having high-volume concurrent transactions may be completed with a delay after the transaction, the bookkeeping process affects the business of the users very little, and is able to satisfy the demand for the account checking of the users. Moreover, the record of a billing, payment and the transaction fund are available for use inquiries, and the fund is available for use within a shorter period of time after the transaction. A short delay may further be configured according to the level of concurrent transactions of an account. Extended resource locking is greatly reduce, which is a desirable result from a system's perspective.

The billing system may conduct a daily summary operation. The disclosed method differs from conventional daily summary operation in that unprocessed buffer record for an object date may exist during the daily summary operation because of buffer bookkeeping. Therefore, an additional processing may be added before the daily summary operation. Specifically, the billing system checks whether any unprocessed buffer records of the object date still exist. If affirmative, such remaining buffer records are first restored and processed before continuing the daily summary operation. Otherwise, the daily summary operation is paused and set to continue after the remaining buffer records have been processed.

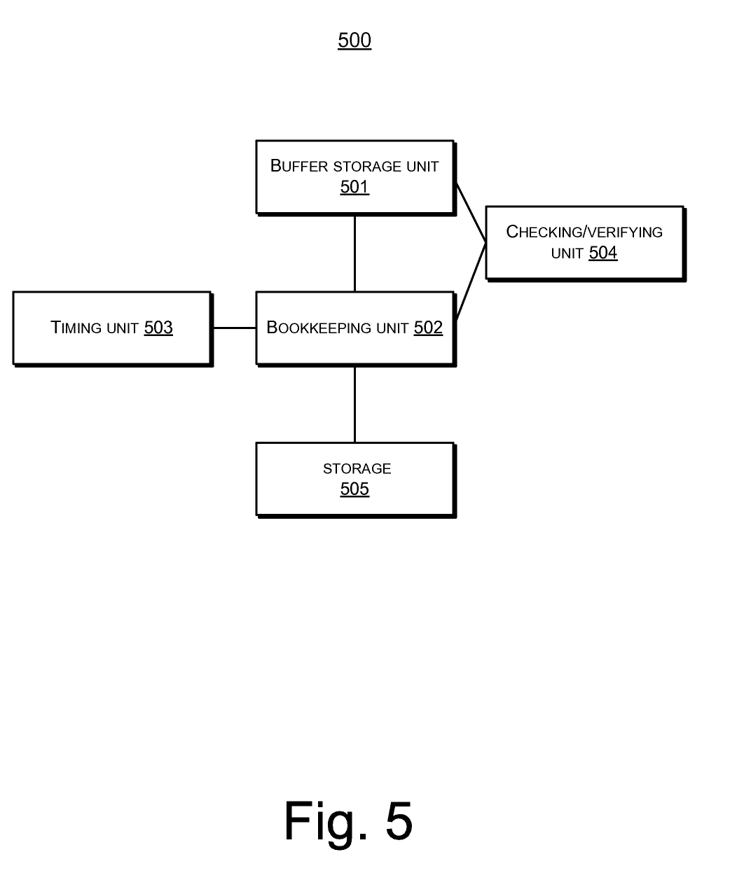

To implement the above-described method for buffered bookkeeping, the present disclosure further provides an exemplary system for buffered bookkeeping. FIG. 5 shows a structural diagram of a first exemplary system 500. The system 500 is a preferably a computerized system for bookkeeping of an account involving financial transactions. As illustrated, the system 500 has a storage 505, a buffer storage unit 501 and a bookkeeping unit 502.

The storage 505 stores a first account (such as a seller's account) and a plurality of second accounts (such as buyer's accounts). In one embodiment, these accounts are virtual accounts established by users in the system 500 which supports a third-party payment platform. Each virtual account is associated with a real financial account such as a bank account of the respective user. The first account has high volume concurrent transactions with the plurality of second accounts. The storage unit 505 may be a storage device such as a database, a server, a hard disk, or a memory.

The buffer storage unit 501 is adapted for recording a plurality of request events initiated on behalf of one or more of the plurality of second accounts to generate a buffer record thereof for the first account. The buffer storage unit 501 may be a storage device such as a database, a server, a hard disk, or a memory. It is appreciated that the buffer storage unit 501 and the storage 505 may either belong to the same integrated storage system, or belong to two separate storage units. The buffer storage unit 501, for example, may be provided by the RAM of the computer which is incorporated into the system 500.

The bookkeeping unit 502 is programmed to fetch and process the buffer record for bookkeeping of the request events in the first account without waiting for a next accounting date. The bookkeeping includes recording bookkeeping information in the account and updating the account. The bookkeeping unit 502 may fetch the buffer record from the buffer storage unit 501 either regularly at predetermined time intervals or recursively.

Preferably, if fetching is done regularly at predetermined time intervals, the system further includes a timing unit 503, which is used for setting the predetermined time intervals, and regularly triggering the bookkeeping unit 502 to fetch the buffer record from the buffer storage unit 501. The time intervals may be configured according to the level of concurrent transactions of the account.

During a bookkeeping process, the bookkeeping unit 502 processes the buffer records one by one. As a buffer record is processed, the related account having high-volume concurrent transactions is locked, and subsequently released after the current buffer record is completely processed. Preferably, after a buffer record is completely processed by the bookkeeping unit 502, the buffer record is deleted from the buffer storage unit 501 to facilitate subsequent daily summary operation.

Preferably, the system further includes a checking/verifying unit 504, which is used for checking and verifying bookkeeping information of a previous accounting date on a daily basis. If any buffer records of the previous accounting date exist in the buffer storage unit 501, the system 500 allows the bookkeeping unit 502 to complete the processing of the remaining buffer records for the bookkeeping first before continuing to check and verify the bookkeeping information of the previous accounting date after.

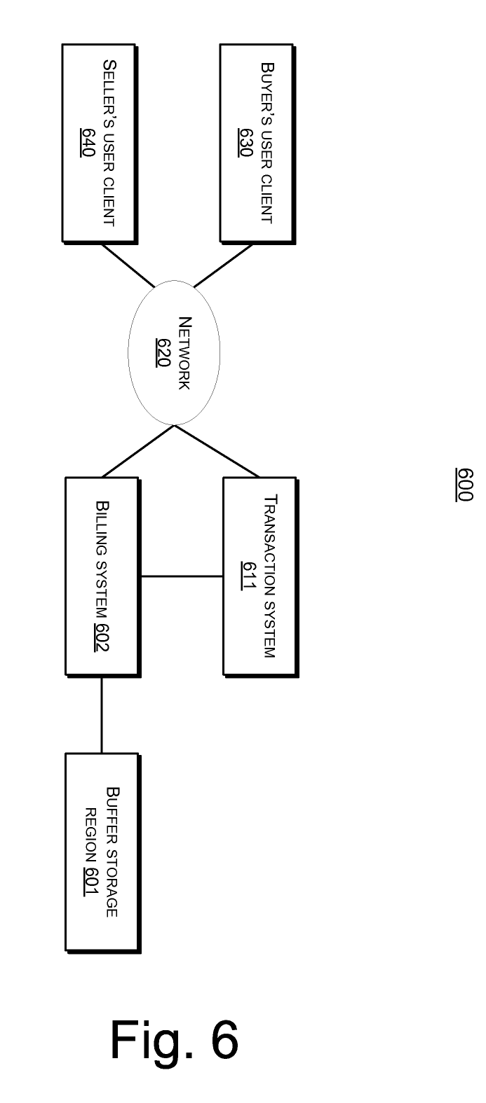

FIG. 6 shows a structural diagram of another exemplary system 600 for buffered bookkeeping in accordance. This exemplary embodiment is an application of the above exemplary system 500 of FIG. 5 in electronic commerce. The system 600 primarily includes a transaction system 611, a billing system 602, and a buffer storage region 601. These components are connected through network 620 to a buyer's user client 630 and a seller's user client 640.

The transaction system 611 is used for processing a network transaction between the buyer's user client 630 and the seller's user client 640, and records related transaction information. The billing system 602 is used for processing a billing or a payment request within a transaction process, which primarily includes operations such as voucher recording and account balance update. The billing system 602 conducts a buffering process for high-volume concurrent requests by recording the requests into the buffer storage region 601, and then fetches buffer records from the buffer storage region 601 to be sequential the processed for buffered bookkeeping of the seller's account.

The billing system 602 may be provided by a third-party payment platform. The transaction system 611 and the billing system 602 may both be provided by a third-party payment platform. Specific manners of implementation can be flexible. Installed within the billing system 602 are virtual accounts of buyers and users. Such accounts may be stored in a storage which is part of the billing system 602. The virtual accounts are separate for the buyer's user client, and the seller's user client. The transaction and fund transfer between the buyer and the seller is achieved using the virtual accounts.

The buyer's user client 630, and the seller's user client 640 accomplish the transaction process through the transaction system 611. If the buyer makes a payment to the seller, the transaction system 611 sends a billing request to the billing system 602. To complete the request, the billing system 602 transfers a transaction fund in the buyer's virtual account to the seller's virtual account.

To concurrently process payments submitted at the same time from multiple buyer accounts to a single seller account, the billing system 602 first places a lock the buyer's virtual account, records a bookkeeping voucher for the account, and updates balance of the account. The billing system 602 then conducts a buffering process for the seller's virtual account by recording associated request event into the buffer storage region 601, and releases the resource lock from the buyer's virtual account upon completion.

The billing system 602 processes the buffer records in the buffer storage region 601 one by one using a periodical fetching method or a recursive fetching method. To process a buffer record, the billing system 602 fetches the buffer record, places a lock on the seller's virtual account, records a bookkeeping voucher according to the buffer record, and updates the balance of the seller's account. The billing system 602 then deletes the processed buffer record from the buffer storage region 601, and releases the resource lock from the seller's virtual account, to complete the processing of the present buffer record. The billing system 602 then returns the processing result of each buffer record to the transaction system 611 which will continue to complete the transaction process using the received processing results.

Through the above processing, the system for buffered bookkeeping can reduce extended locking of the account resources, improve the efficiency of the concurrent processing, and achieve synchronous update of billing details and account balance. This satisfies account checking requirements of both the buyer and the seller.

Any omitted details in FIG. 5 and FIG. 6 can be referenced to their related portions described in connection with the methods in FIG. 2 to FIG. 4.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for computerized bookkeeping of an account involving financial transactions, the method comprising:
recording a plurality of request events to generate a buffer record thereof for an account having high-volume concurrent transactions; and
fetching and processing the buffer record for bookkeeping of the request events in the account without waiting for a next accounting date, wherein the bookkeeping including recording bookkeeping information into the account and updating the account balance.

2. The method as recited in claim 1, wherein fetching and processing the buffer record is performed at predetermined time intervals.

3. The method as recited in claim 1, wherein fetching and processed in the buffer record is performed recursively.

4. The method as recited in claim 1, wherein processing the buffer record comprises:
dividing the buffer record into a plurality of records each containing request events sent from another respective account;
assigning a processing thread to each of the plurality of records to process the plurality of records in the background.

5. The method as recited in claim 1, wherein processing the buffer record comprises:
placing a resource lock on the account having high-volume concurrent transactions;
performing bookkeeping including recording the bookkeeping information and updating the account; and
releasing the resource lock.

6. The method as recited in claim 1, further comprising:
deleting the buffer record after the buffer record has been processed.

7. The method as recited in claim 1, further comprising:
checking and verifying bookkeeping information of a previous accounting date on a daily basis.

8. The method as recited in claim 7, further comprising:
fetching and processing any remaining buffer record unprocessed from the previous accounting date before checking and verifying the bookkeeping information of the previous accounting date.

9. The method as recited in claim 1, wherein recording request events is performed continuously to generate a plurality of buffer records each comprising a plurality of request events, and the method further comprises:
sequentially fetching and processing the plurality of buffer records for bookkeeping of the request events in the account without waiting for a next accounting date.

10. A method for computerized bookkeeping of an account involving financial transactions, the method comprising:
establishing a first account and a plurality of second accounts, wherein the first account has high-volume concurrent transactions with the plurality of second accounts;
receiving a plurality of request events initiated on behalf of one or more of the plurality of second accounts;
processing each of the request events as the request event takes place for bookkeeping of the respective second account which initiated the request event;
recording the plurality of request events to generate a buffer record thereof for the first account; and
fetching and processing the buffer record for bookkeeping of the request events in the first account without waiting for a next accounting date, wherein the bookkeeping including recording bookkeeping information into the account and updating the account balance.

11. The method as recited in claim 10, wherein receiving request events and recording request events are performed continuously to generate a plurality of buffer records each comprising a plurality of request events, and the method further comprises:
sequentially fetching and processing the plurality of buffer records for bookkeeping of the request events in the first account without waiting for a next accounting date.

12. The method as recited in claim 11, wherein sequentially fetching and processing the plurality of buffer records comprises:
fetching and processing the plurality of buffer records one by one at predetermined time intervals.

13. The method as recited in claim 11, wherein sequentially fetching and processing the plurality of buffer records comprises:
fetching and processing the plurality of buffer records one by one recursively.

14. A system for computerized bookkeeping of an account involving financial transactions, the system comprising:
a storage storing a first account and a plurality of second accounts, wherein the first account has high-volume concurrent transactions with the plurality of second accounts;
a buffer storage unit adapted for recording a plurality of request events initiated on behalf of one or more of the plurality of second accounts to generate a buffer record thereof for the first account; and
a bookkeeping unit programmed to fetch and process the buffer record for bookkeeping of the request events in the first account without waiting for a next accounting date, wherein the bookkeeping includes recording bookkeeping information in the account and updating the account balance.

15. The system as recited in claim 14, wherein the system further comprises:
a checking/verifying unit programmed for fetching and processing any remaining buffer record unprocessed from a previous accounting date, and checking and verifying the bookkeeping information of the previous accounting date.

16. The system as recited in claim 14, wherein the bookkeeping unit is adapted for fetching and processing the buffer record from the buffer storage unit at predetermined time intervals or recursively.
